(19) United States
(12) Patent Application Publication
(10) Pub. No.: US 2026/0281146 A1
(43) Pub. Date: Sep. 17, 2026

(54) SYSTEM FOR PREVENTING INTERNET CRIMINAL ACTS

(71) Applicant: SoftBank Group Corp., Tokyo (JP)

(72) Inventor: Takeaki YOSHII, Tokyo (JP)

(21) Appl. No.: 19/560,135

(22) Filed: Mar. 9, 2026

Related U.S. Application Data
(60) Provisional application No. 63/770,420, filed on Mar. 12, 2025.

(51) Int. Cl. H04L 9/40; G06F 40/279

(52) U.S. Cl. CPC H04L 63/1433; G06F 40/279; H04L 63/1425

(57) ABSTRACT

A system for preventing potential criminal acts on the Internet. In this system, an input unit implemented in a user's terminal monitors online activities in real time and collects data. An analysis unit implemented on a server analyzes the data using natural language processing technology and detects keywords related to crime. An identification unit identifies a related device or account using identification information on a network, and a history collection unit comprehensively collects past usage history. An evaluation unit evaluates potential risks using a machine learning algorithm, and a warning unit issues a warning to a law enforcement agency.

### CROSS-REFERENCE TO RELATED APPLICATIONS

This application is based upon and claims the benefit of priority from U.S. Provisional Patent Application No. 63/770,420, filed on Mar. 12, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the said user utterance to a prompt including an instruction sentence associated with a description regarding a character of a chatbot, a step of encoding the said prompt, and a step of inputting the said encoded prompt to a language model to generate a chatbot utterance responding to the said user utterance.

### SUMMARY

A problem to be solved by this disclosure is to prevent potential criminal acts on the Internet. For example, an object is to detect behavior including keywords that may be related to crime in online communication and search activities, and to identify individuals or devices with potential risks based on this. In modern society, crimes via the Internet are increasing, and in order to address this, it is required to quickly and accurately detect potential dangers and take appropriate measures. However, with related art methods, it is difficult to identify risks from a vast amount of data, and there is also a risk that innocent individuals may be unjustly suspected due to erroneous judgments. It is possible to evaluate risks with higher accuracy by utilizing natural language processing and machine learning technologies, and to respond promptly in cooperation with law enforcement agencies. Thereby, it is expected to improve the safety of society as a whole and contribute to the prevention of crime.

Furthermore, from a technical perspective, communication traffic on the Internet is enormous, and monitoring this in real time to understand context and determine danger presents a problem in that processing delay (latency) is significant and practical application is difficult with simple keyword matching by a conventional general-purpose computer. In addition, there is a technical problem in that due to the polysemy of words (e.g., whether “bomb” refers to a movie topic or an actual threat), false positives occur frequently, wastefully consuming computational resources and network bandwidth. Therefore, a technical solution that identifies danger with high precision and in real time is provided while suppressing computational load by organically combining specific vectorization processing and anomaly detection algorithms in natural language processing with hardware resources.

Disclosed herein is a system including an input unit that receives input data, an analysis unit that analyzes the received input data to detect specific keywords, an identification unit that identifies a related device or account based on the keywords detected by the analysis unit, a history collection unit that collects past usage history of the identified device or account, an evaluation unit that analyzes the collected usage history to evaluate potential risks, and a warning unit that issues a warning based on the evaluation result. The input unit receives communication data and search data on the Internet in real time, and the analysis unit analyzes these data using natural language processing technology to detect keywords that may be related to crime with high accuracy. The identification unit quickly identifies a device or account related to the keywords detected by the analysis unit using identification information on the network, and the history collection unit comprehensively collects the past usage history of the identified device or account by cross-referencing from multiple databases. The evaluation unit analyzes the collected usage history using a machine learning algorithm to quantitatively evaluate potential risks, and the warning unit automatically issues a warning to a law enforcement agency when the evaluation unit determines that the risk is high. This makes it possible to prevent potential criminal acts and improve the safety of society.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method of preventing internet criminal acts.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

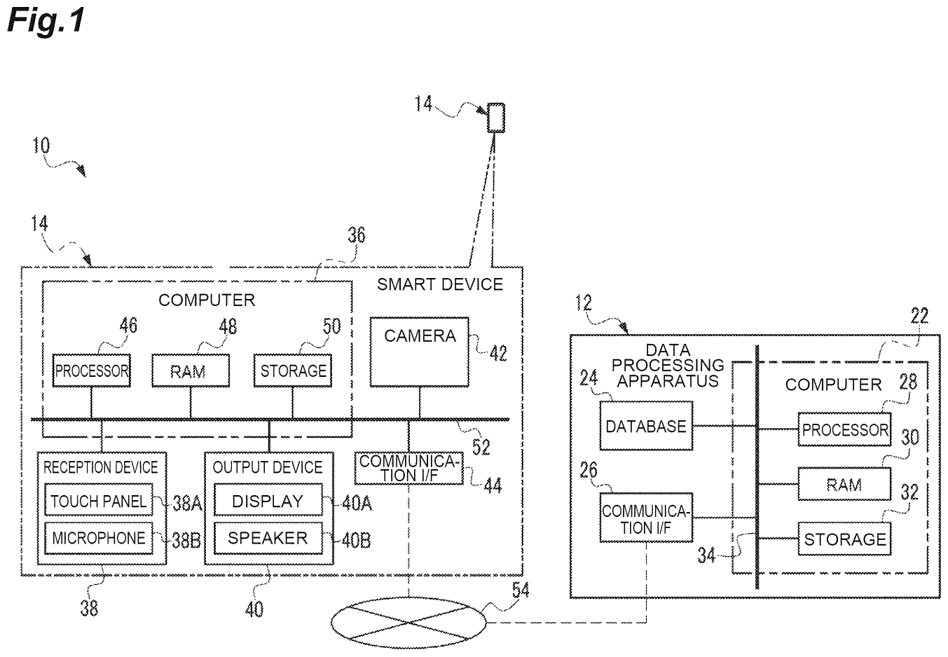

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, an identification processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

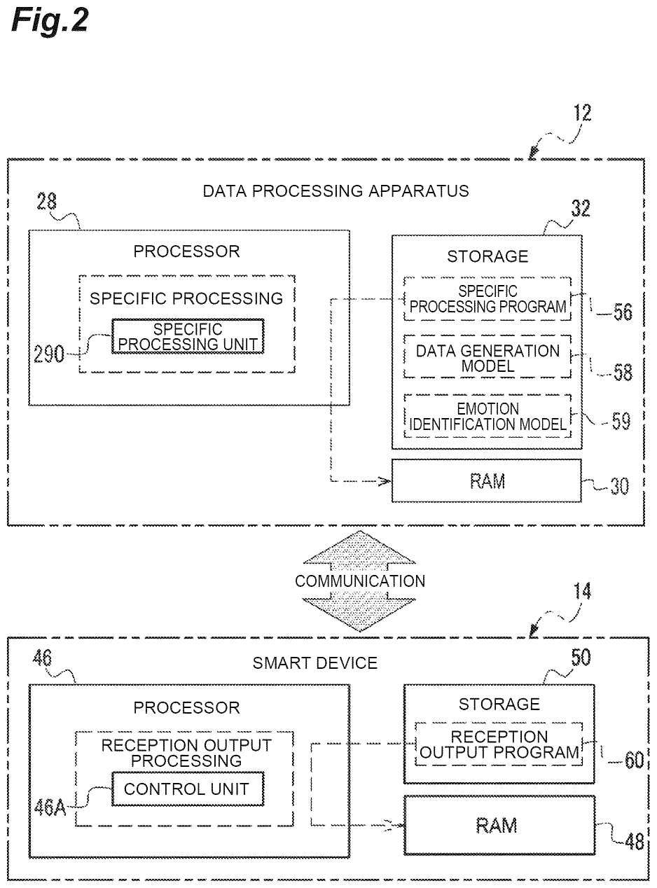

FIG. 2 illustrates an example of main functions of the data processing apparatus 12 and the smart device 14.

As illustrated in FIG. 2, in the data processing apparatus 12, identification processing is performed by the processor 28. An identification processing program 56 is stored in the storage 32. The identification processing program 56 is an example of a “program” according to the technology of the present disclosure. The processor 28 reads the identification processing program 56 from the storage 32 and executes the read identification processing program 56 on the RAM 30. The identification processing is realized by the processor 28 operating as an identification processing unit 290 in accordance with the identification processing program 56 executed on the RAM 30.

A data generation model 58 and an emotion identification model 59 are stored in the storage 32. The data generation model 58 and the emotion identification model 59 are used by the identification processing unit 290. The identification processing unit 290 can estimate a user's emotion using the emotion identification model 59 and perform identification processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

The identification processing unit 290 executes vectorization processing that maps input text data to a high-dimensional vector space by utilizing the parallel computing capability of the processor 28 (including, for example, AI accelerators such as a GPU or a TPU). At this time, the RAM 30 is configured to hold frequently appearing keywords and vector data as a cache to reduce the frequency of access to the storage 32, thereby improving throughput in real-time processing. Further, the identification processing program 56 includes weight parameters of a neural network, and these are expanded in a dedicated register or a local memory within the processor 28 to realize high-speed inference processing.

In the smart device 14, reception output processing is performed by the processor 46. A reception output program 60 is stored in the storage 50. The reception output program 60 is used in combination with the identification processing program 56 by the data processing system 10. The processor 46 reads the reception output program 60 from the storage 50 and executes the read reception output program 60 on the RAM 48. The identification processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the identification processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of identification processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

The functions of each unit in a system configured using a server and a terminal are shared in detail as follows.

First, the input unit is implemented in a user's terminal. This terminal is a device that the user uses on a daily basis, such as a smartphone, a tablet, a laptop computer, or a desktop computer. The input unit monitors various activities that the user performs on the Internet in real time, such as sending messages on SNS, sending and receiving emails, searching for information using a search engine, and searching for products on an online shopping site, and collects data. This makes it possible to detect unintended fraudulent acts or dangerous behavior of the user at an early stage.

The input unit may be configured by, for example, the reception device 38 (the touch panel 38A, the microphone 38B, etc.) of the smart device 14.

Next, the analysis unit is implemented on a high-performance server. This server is placed in a cloud environment and has the ability to efficiently process a large amount of data transmitted from multiple terminals. The analysis unit analyzes words and phrases in the received data using natural language processing technology. For example, it performs morphological analysis and contextual analysis to detect keywords that may be related to crime with high accuracy. For example, if keywords such as “bomb,” “attack,” “illegal drugs,” “terrorism,” or “hacking” are included, it detects them and proceeds to the next process. The analysis unit utilizes the latest AI technology and continuously learns to improve the detection accuracy of keywords.

As specific processing by the analysis unit, first, morphological analysis is performed on input data, and tokenized words are vectorized using an embedding technology such as Word2Vec or BERT (Bidirectional Encoder Representations from Transformers). The analysis unit detects not only simple keyword matches but also suggestions of crime using slang or synonyms by calculating distances (cosine similarity, etc.) between words in the vector space. Furthermore, the analysis unit uses an Attention Mechanism to weight the degree of influence that a specific word in a sentence has on the entire context, and performs filtering processing to dynamically lower a risk score when the word co-occurs with words indicating a harmless context such as “movie” or “game,” for example. This filtering processing significantly reduces the computational load in the subsequent evaluation unit.

The analysis unit may be configured by, for example, the computer 22 (the processor 28, etc.) of the data processing apparatus 12, or may be configured by the identification processing unit 290, the identification processing program 56, the data generation model 58, and the like.

The identification unit is also implemented on the server and identifies a related device or account based on the keywords detected by the analysis unit. This identification is performed using identification information on the network, for example, an IP address, a MAC address, a user ID, cookie information, and the like. This makes it possible to quickly identify a user or device that has used a specific keyword. The identification unit also has a function to monitor network traffic and detect abnormal access patterns or fraudulent login attempts.

The identification unit may be configured by, for example, the computer 22 (the processor 28, etc.) of the data processing apparatus 12, or may be configured by the identification processing unit 290, the identification processing program 56, the data generation model 58, and the like.

The history collection unit operates in cooperation with the identification unit and collects the past usage history of the identified device or account. This history is comprehensively collected by cross-referencing from multiple databases. For example, it includes a history of using similar keywords in the past, a browsing history of related websites, a history of online transactions, a history of past posts on SNS, a history of sending and receiving emails, and the like. The history collection unit uses an optimized algorithm to quickly collect information while maintaining data integrity.

The history collection unit may be configured by, for example, the computer 22 (the processor 28, etc.) of the data processing apparatus 12, or may be configured by the identification processing unit 290, the identification processing program 56, the data generation model 58, and the like.

The evaluation unit is implemented on the server and analyzes the collected usage history using a machine learning algorithm. This makes it possible to quantitatively evaluate potential risks. For example, if it is determined based on past data that a specific behavior pattern is highly likely to be related to a crime, the risk is quantified and evaluated. The evaluation unit has a function to automatically identify behavior that is different from normal using an anomaly detection algorithm and calculate a risk score.

As a specific algorithm for analysis by the evaluation unit, a recurrent neural network using LSTM (Long Short-Term Memory) or GRU (Gated Recurrent Unit) is adopted to perform anomaly detection from usage history as time-series data. The evaluation unit learns a user's behavior pattern during normal times (baseline) and calculates a degree of divergence (Anomaly Score) between current input data and the baseline. Only when this degree of divergence exceeds a predetermined threshold, it is determined that the potential risk is high. This processing extracts minute changes in patterns that are precursors to crime from a vast amount of history data at a level unrecognizable by humans.

The evaluation unit may be configured by, for example, the computer 22 (the processor 28, etc.) of the data processing apparatus 12, or may be configured by the identification processing unit 290, the identification processing program 56, the data generation model 58, and the like.

Finally, the warning unit is implemented on the server and automatically issues a warning to a law enforcement agency when the evaluation unit determines that the risk is high. This warning is transmitted using email, SMS, or a dedicated communication protocol, enabling a prompt response. For example, if a specific keyword is used frequently and the past history indicates a risk, a warning is issued immediately. The warning unit is provided with a function to securely transmit information using encrypted communication in order to strengthen cooperation with law enforcement agencies.

The warning processing by the warning unit is not limited to simple transmission of a message but can include active network control for the identified device or account. For example, when it is determined that the risk is extremely high, the warning unit transmits a control signal to a network device (a router or a gateway) via the communication I/F 26 to temporarily block (filter) communication packets from the device or dynamically apply a setting to redirect a communication path to a server of a law enforcement agency. In addition, in data transmission to the law enforcement agency, a dedicated secure protocol using a public key encryption method is established, and the data is generated and transmitted as a packet to which an electronic signature for evidence preservation is added.

The warning unit may be configured by, for example, the computer 22 (the processor 28, etc.) of the data processing apparatus 12, or may be configured by the identification processing unit 290, the identification processing program 56, the data generation model 58, and the like.

As described above, a comprehensive system for preventing potential criminal acts on the Internet through the cooperation of a server and a terminal is provided. This system is provided with respective functions of real-time data collection, analysis, identification, history collection, evaluation, and warning, and aims to improve the safety of society.

### (Implementation Steps)

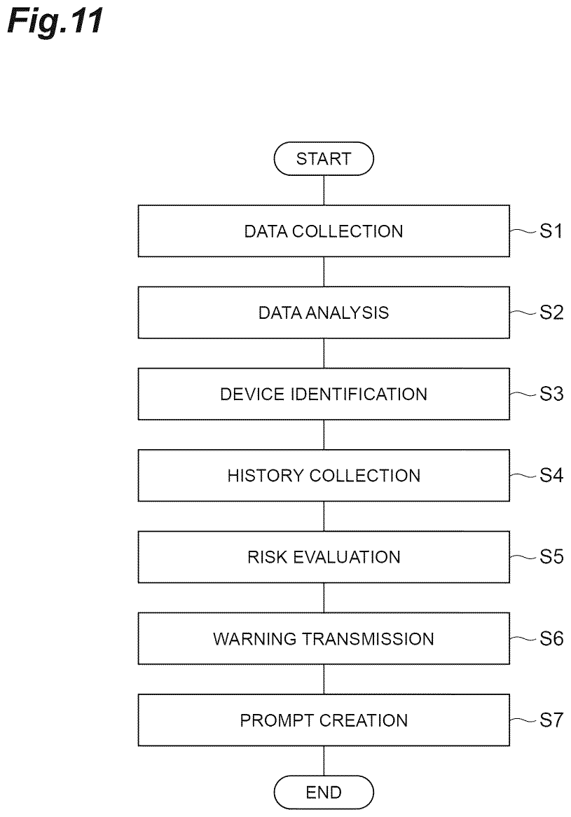

Step 1: Data Collection Step (refer to step S1 of FIG. 11) In this step, an input unit implemented in a user's terminal monitors the user's activities on the Internet in real time and collects data. For example, it targets various online activities performed by the user, such as sending messages on SNS, sending and receiving emails, searching for information using a search engine, and searching for products on an online shopping site. This makes it possible to detect unintended fraudulent acts or dangerous behavior of the user at an early stage.

Step 2: Data Analysis Step (refer to step S2 of FIG. 11) Next, an analysis unit implemented on a server receives data transmitted from a terminal and performs analysis using natural language processing technology. For example, it analyzes words and phrases in the received data and detects keywords that may be related to crime. For example, if keywords such as “bomb,” “attack,” “illegal drugs,” “terrorism,” or “hacking” are included, it detects them and proceeds to the next process. The analysis unit operates on a server equipped with a high-performance processor and a large-capacity memory in order to quickly process a large amount of data.

Step 3: Device Identification Step (refer to step S3 of FIG. 11) Based on the keywords detected by the analysis unit, an identification unit identifies a related device or account. This identification is performed using identification information on the network, for example, an IP address, a MAC address, a user ID, cookie information, and the like. This makes it possible to quickly identify a user or device that has used a specific keyword. The identification unit also has a function to monitor network traffic and detect abnormal access patterns or fraudulent login attempts.

Step 4: History Collection Step (refer to step S4 of FIG. 11) A history collection unit that operates in cooperation with the identification unit collects the past usage history of the identified device or account. This history is comprehensively collected by cross-referencing from multiple databases. For example, it includes a history of using similar keywords in the past, a browsing history of related websites, a history of online transactions, a history of past posts on SNS, a history of sending and receiving emails, and the like. The history collection unit uses an optimized algorithm to quickly collect information while maintaining data integrity.

Step 5: Risk Evaluation Step (refer to step S5 of FIG. 11) Based on the collected usage history, an evaluation unit performs analysis using a machine learning algorithm and quantitatively evaluates potential risks. For example, if it is determined based on past data that a specific behavior pattern is highly likely to be related to a crime, the risk is quantified and evaluated. The evaluation unit has a function to automatically identify behavior that is different from normal using an anomaly detection algorithm and calculate a risk score.

Step 6: Warning Issuance Step (refer to step S6 of FIG. 11) When the evaluation unit determines that the risk is high, a warning unit automatically issues a warning to a law enforcement agency. This warning is transmitted using email, SMS, or a dedicated communication protocol, enabling a prompt response. For example, if a specific keyword is used frequently and the past history indicates a risk, a warning is issued immediately. The warning unit is provided with a function to securely transmit information using encrypted communication in order to strengthen cooperation with law enforcement agencies.

Step 7: Generative AI Prompt Creation Step (refer to step S7 of FIG. 11)

In the step of using a generative AI, a prompt sentence to be read by the AI is created. Specific examples include prompts such as “Analyze the messages used by the user on SNS and detect keywords related to crime” and “Evaluate potential risks based on the search history in the search engine.” This allows the AI to efficiently execute the specified tasks and improve the accuracy of the entire system.

### (Specific Use Case)

For example, assume that a certain user is searching for specific information using a search engine on the Internet. The input unit is implemented in this user's terminal and monitors the search queries input by the user in real time. If the user inputs a query including risky keywords such as “how to obtain illegal drugs” or “how to make a bomb,” the input unit immediately detects this and transmits the data to the server.

The analysis unit implemented on the server analyzes the received data using natural language processing technology and detects risky keywords with high accuracy. The analysis unit not only detects keywords but also considers the context to determine the intent. For example, even if the word “bomb” is included, the risk assessment differs between a case where it is a movie review and a case where the user is searching for a specific manufacturing method. In this way, the analysis unit reduces false detections and improves accuracy by understanding the context.

If the analysis unit determines that there is a risk, the identification unit uses identification information on the network to identify the related device or account. For example, a specific user can be quickly identified using an IP address or a user ID. This makes it possible to identify a user who may be engaging in dangerous behavior and proceed to the next step.

The past usage history of the identified user is collected by the history collection unit. The history collection unit performs cross-referencing from multiple databases to collect a comprehensive history. For example, it includes a history of using similar keywords in the past, a browsing history of related websites, a history of past posts on SNS, and the like. This makes it possible to grasp the user's behavior patterns in detail.

The collected history data is analyzed by the evaluation unit using a machine learning algorithm, and the potential risk is quantitatively evaluated. The evaluation unit uses an anomaly detection algorithm to automatically identify behavior that is different from normal and calculates a risk score. For example, if it is determined based on past data that a specific behavior pattern is highly likely to be related to a crime, the risk is quantified and evaluated.

Based on the evaluation result, the warning unit automatically issues a warning to a law enforcement agency. The warning is transmitted using email or a dedicated communication protocol, enabling a prompt response. For example, if a specific keyword is used frequently and the past history indicates a risk, a warning is issued immediately. The warning unit is provided with a function to securely transmit information using encrypted communication in order to strengthen cooperation with law enforcement agencies.

In the step of using a generative AI, a prompt sentence to be read by the AI is created. Specific examples include prompts such as “Analyze the messages used by the user on SNS and detect keywords related to crime” and “Evaluate potential risks based on the search history in the search engine.” This allows the AI to efficiently execute the specified tasks and improve the accuracy of the entire system.

### Example 1.2

A flow of identification processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

### (Implementation Steps)

### Step 1: Data Collection Step

In this step, a data collection unit implemented in a user's terminal monitors the user's activities on the Internet in real time and collects data. For example, it targets various online activities performed by the user, such as sending messages on SNS, sending and receiving emails, searching for information using a search engine, and searching for products on an online shopping site. This makes it possible to detect unintended fraudulent acts or dangerous behavior of the user at an early stage.

### Step 2: Data Analysis Step

Next, an analysis unit implemented on a server receives data transmitted from a terminal and performs analysis using natural language processing technology. For example, it analyzes words and phrases in the received data and detects keywords that may be related to crime. For example, if keywords such as “bomb,” “attack,” “illegal drugs,” “terrorism,” or “hacking” are included, it detects them and proceeds to the next process. The analysis unit operates on a server equipped with a high-performance processor and a large-capacity memory in order to quickly process a large amount of data.

### Step 3: Device Identification Step

Based on the keywords detected by the analysis unit, an identification unit identifies a related device or account. This identification is performed using identification information on the network, for example, an IP address, a MAC address, a user ID, cookie information, and the like. This makes it possible to quickly identify a user or device that has used a specific keyword. The identification unit also has a function to monitor network traffic and detect abnormal access patterns or fraudulent login attempts.

### Step 4: History Collection Step

A history collection unit that operates in cooperation with the identification unit collects the past usage history of the identified device or account. This history is comprehensively collected by cross-referencing from multiple databases. For example, it includes a history of using similar keywords in the past, a browsing history of related websites, a history of online transactions, a history of past posts on SNS, a history of sending and receiving emails, and the like. The history collection unit uses an optimized algorithm to quickly collect information while maintaining data integrity.

### Step 5: Risk Evaluation Step

Based on the collected usage history, an evaluation unit performs analysis using a machine learning algorithm and quantitatively evaluates potential risks. For example, if it is determined based on past data that a specific behavior pattern is highly likely to be related to a crime, the risk is quantified and evaluated. The evaluation unit has a function to automatically identify behavior that is different from normal using an anomaly detection algorithm and calculate a risk score.

### Step 6: Warning Issuance Step

When the evaluation unit determines that the risk is high, a warning unit automatically issues a warning to a law enforcement agency. This warning is transmitted using email, SMS, or a dedicated communication protocol, enabling a prompt response. For example, if a specific keyword is used frequently and the past history indicates a risk, a warning is issued immediately. The warning unit is provided with a function to securely transmit information using encrypted communication in order to strengthen cooperation with law enforcement agencies.

### Step 7: Generative AI Prompt Creation Step

In the step of using a generative AI, a prompt sentence to be read by the AI is created. Specific examples include prompts such as “Analyze the messages used by the user on SNS and detect keywords related to crime” and “Evaluate potential risks based on the search history in the search engine.” This allows the AI to efficiently execute the specified tasks and improve the accuracy of the entire system.

### (Specific Use Case)

The identification processing unit 290 transmits a result of the identification processing to the smart device 14. In the smart device 14, the control unit 46A causes the output device 40 to output the result of the identification processing. The microphone 38B acquires voice indicating a user input for the result of the identification processing. The control unit 46A transmits voice data indicating the user input acquired by the microphone 38B to the data processing apparatus 12. In the data processing apparatus 12, the identification processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The identification processing unit 290 performs the above-described identification processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the identification processing unit 290 of the data processing apparatus 12 or the control unit 46A of the smart device 14, but may also be executed by the identification processing unit 290 of the data processing apparatus 12 and the control unit 46A of the smart device 14. Also, the identification processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the identification processing unit 290 of the data processing apparatus 12. For example, an acquisition unit acquires step count data using the camera 42 or the communication I/F 44 of the smart device 14, and the data is processed by the identification processing unit 290 of the data processing apparatus 12. For example, an analysis unit is realized by the identification processing unit 290 of the data processing apparatus 12, and analyzes data from the collection unit and the acquisition unit. For example, a generation unit is realized by the identification processing unit 290 of the data processing apparatus 12, and generates a cooking menu using a generative AI. For example, a provision unit is realized by the output device 40 of the smart device 14 or the identification processing unit 290 of the data processing apparatus 12, and provides the generated cooking menu to a user. The correspondence relationship between each unit and the device or the control unit is not limited to the above-described example, and various changes are possible.

An example form in which the identification processing is performed by the data processing apparatus 12 has been described, but the technology of the present disclosure is not limited to this, and the identification processing may be performed by the smart device 14.

### Second Embodiment

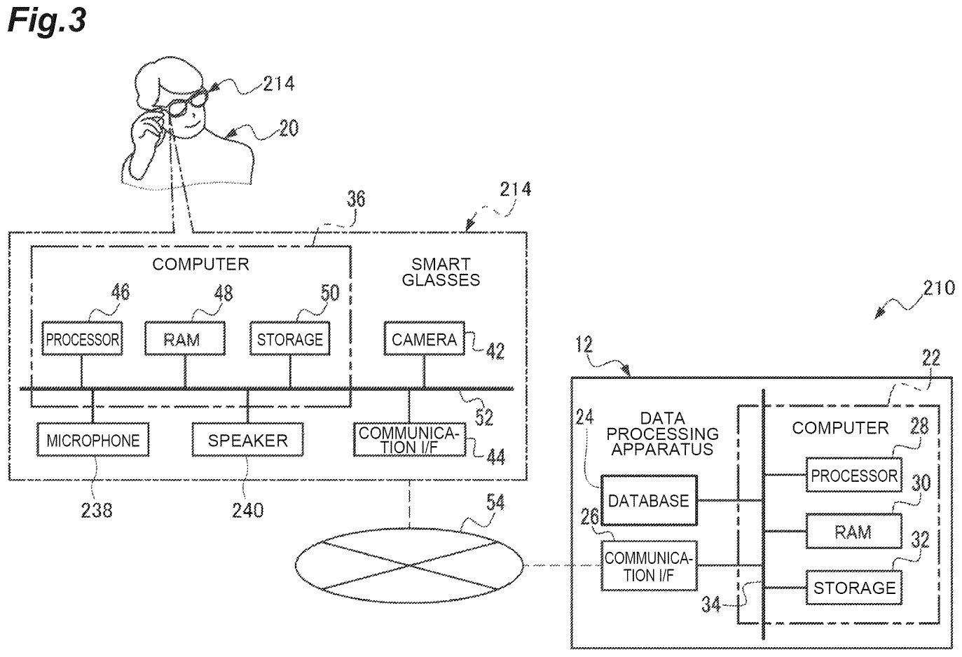

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

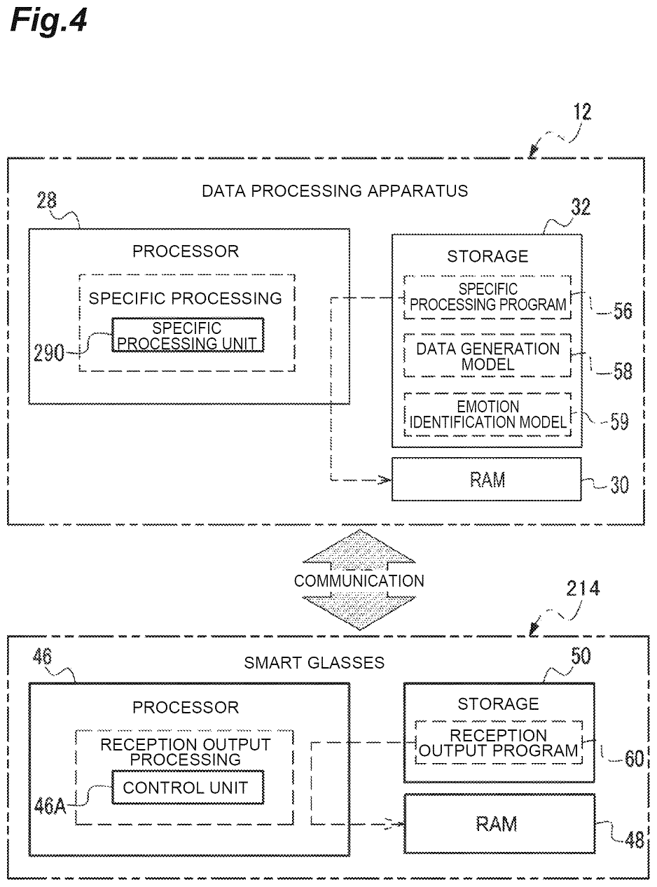

FIG. 4 illustrates an example of main functions of the data processing apparatus 12 and the smart glasses 214. As illustrated in FIG. 4, in the data processing apparatus 12, identification processing is performed by the processor 28. An identification processing program 56 is stored in the storage 32.

The identification processing program 56 is an example of a “program” according to the technology of the present disclosure. The processor 28 reads the identification processing program 56 from the storage 32 and executes the read identification processing program 56 on the RAM 30. The identification processing is realized by the processor 28 operating as an identification processing unit 290 in accordance with the identification processing program 56 executed on the RAM 30.

A data generation model 58 and an emotion identification model 59 are stored in the storage 32. The data generation model 58 and the emotion identification model 59 are used by the identification processing unit 290. The identification processing unit 290 can estimate a user's emotion using the emotion identification model 59 and perform identification processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the identification processing unit 290 using these models.

Next, identification processing by the identification processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the identification processing is the same as that in Example 1.1 described in the first embodiment, a description thereof is omitted.

### Example 2.2

Since the flow of the identification processing is the same as that in Example 1.2 described in the first embodiment, a description thereof is omitted.

The identification processing unit 290 transmits a result of the identification processing to the smart glasses 214. In the smart glasses 214, the control unit 46A causes the speaker 240 to output the result of the identification processing. The microphone 238 acquires voice indicating a user input for the result of the identification processing. The control unit 46A transmits voice data indicating the user input acquired by the microphone 238 to the data processing apparatus 12. In the data processing apparatus 12, the identification processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The identification processing unit 290 performs the above-described identification processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the identification processing unit 290 of the data processing apparatus 12 or the control unit 46A of the smart device 14, but may also be executed by the identification processing unit 290 of the data processing apparatus 12 and the control unit 46A of the smart device 14. Also, the identification processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the identification processing unit 290 of the data processing apparatus 12. For example, an acquisition unit acquires step count data using the camera 42 or the communication I/F 44 of the smart device 14, and the data is processed by the identification processing unit 290 of the data processing apparatus 12. For example, an analysis unit is realized by the identification processing unit 290 of the data processing apparatus 12, and analyzes data from the collection unit and the acquisition unit. For example, a generation unit is realized by the identification processing unit 290 of the data processing apparatus 12, and generates a cooking menu using a generative AI. For example, a provision unit is realized by the output device 40 of the smart device 14 or the identification processing unit 290 of the data processing apparatus 12, and provides the generated cooking menu to a user. The correspondence relationship between each unit and the device or the control unit is not limited to the above-described example, and various changes are possible.

An example form in which the identification processing is performed by the data processing apparatus 12 has been described, but the technology of the present disclosure is not limited to this, and the identification processing may be performed by the smart glasses 214.

### Third Embodiment

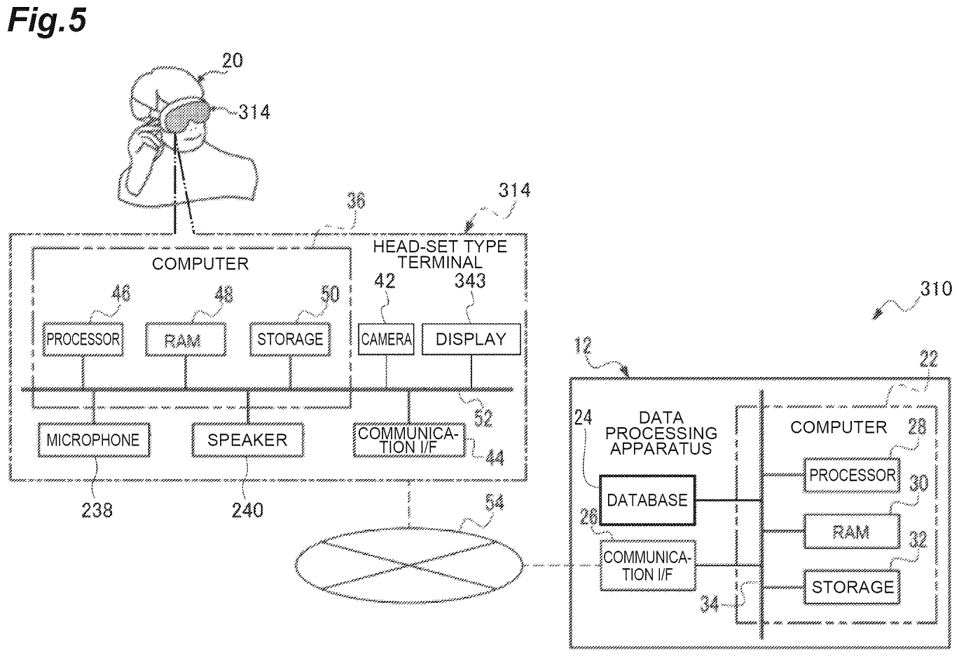

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

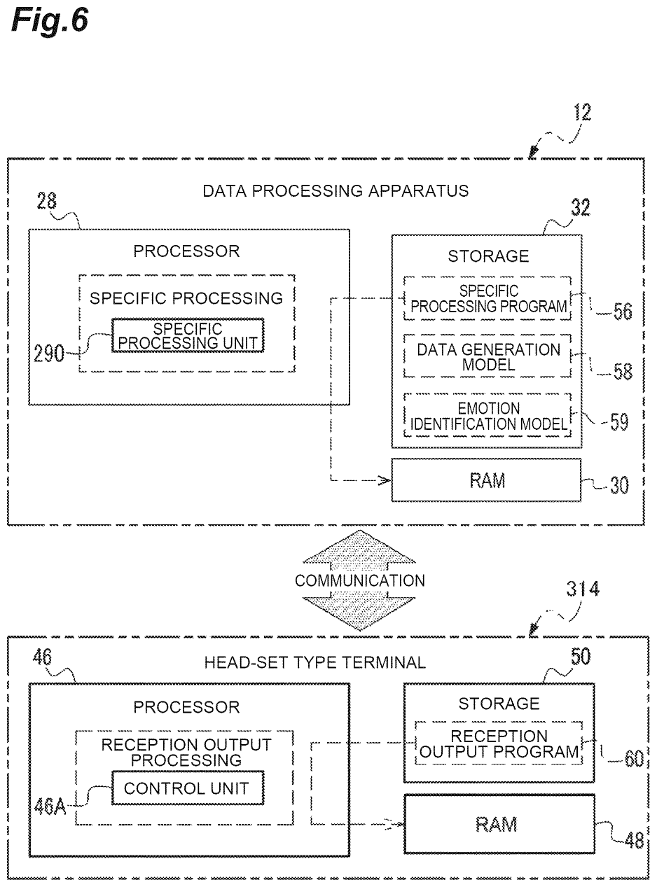

FIG. 6 illustrates an example of main functions of the data processing apparatus 12 and the headset-type terminal 314. As illustrated in FIG. 6, in the data processing apparatus 12, identification processing is performed by the processor 28. An identification processing program 56 is stored in the storage 32.

The identification processing program 56 is an example of a “program” according to the technology of the present disclosure. The processor 28 reads the identification processing program 56 from the storage 32 and executes the read identification processing program 56 on the RAM 30. The identification processing is realized by the processor 28 operating as an identification processing unit 290 in accordance with the identification processing program 56 executed on the RAM 30.

A data generation model 58 and an emotion identification model 59 are stored in the storage 32. The data generation model 58 and the emotion identification model 59 are used by the identification processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, identification processing by the identification processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the identification processing is the same as that in Example 1.1 described in the first embodiment, a description thereof is omitted.

### Example 3.2

Since the flow of the identification processing is the same as that in Example 1.2 described in the first embodiment, a description thereof is omitted.

The identification processing unit 290 transmits a result of the identification processing to the headset-type terminal 314. In the headset-type terminal 314, the control unit 46A causes the speaker 240 and the display 343 to output the result of the identification processing. The microphone 238 acquires voice indicating a user input for the result of the identification processing. The control unit 46A transmits voice data indicating the user input acquired by the microphone 238 to the data processing apparatus 12. In the data processing apparatus 12, the identification processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The identification processing unit 290 performs the above-described identification processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the identification processing unit 290 of the data processing apparatus 12 or the control unit 46A of the smart device 14, but may also be executed by the identification processing unit 290 of the data processing apparatus 12 and the control unit 46A of the smart device 14. Also, the identification processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the identification processing unit 290 of the data processing apparatus 12. For example, an acquisition unit acquires step count data using the camera 42 or the communication I/F 44 of the smart device 14, and the data is processed by the identification processing unit 290 of the data processing apparatus 12. For example, an analysis unit is realized by the identification processing unit 290 of the data processing apparatus 12, and analyzes data from the collection unit and the acquisition unit. For example, a generation unit is realized by the identification processing unit 290 of the data processing apparatus 12, and generates a cooking menu using a generative AI. For example, a provision unit is realized by the output device 40 of the smart device 14 or the identification processing unit 290 of the data processing apparatus 12, and provides the generated cooking menu to a user. The correspondence relationship between each unit and the device or the control unit is not limited to the above-described example, and various changes are possible.

An example form in which the identification processing is performed by the data processing apparatus 12 has been described, but the technology of the present disclosure is not limited to this, and the identification processing may be performed by the headset-type terminal 314.

### Fourth Embodiment

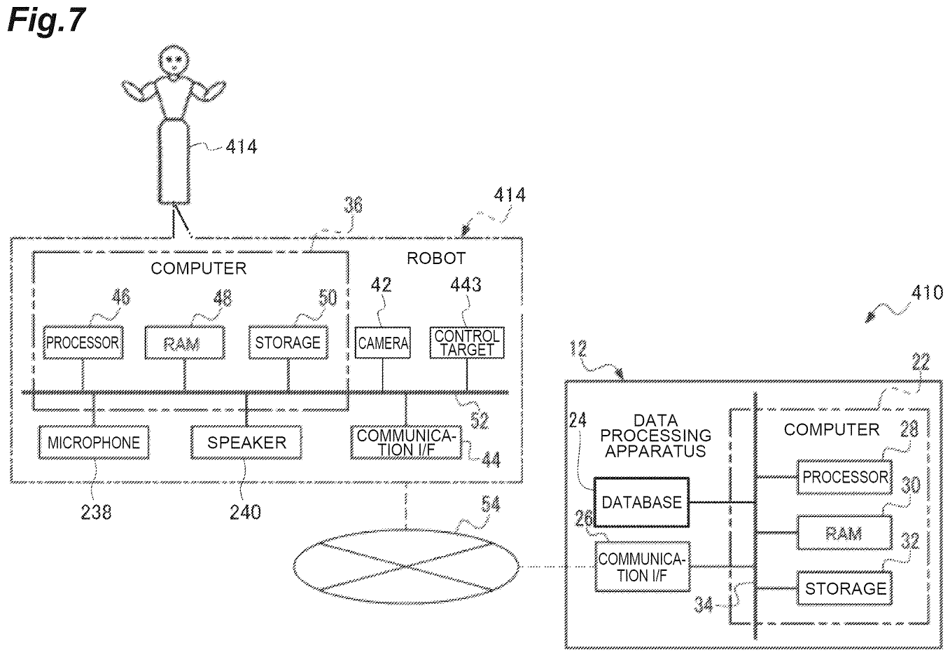

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

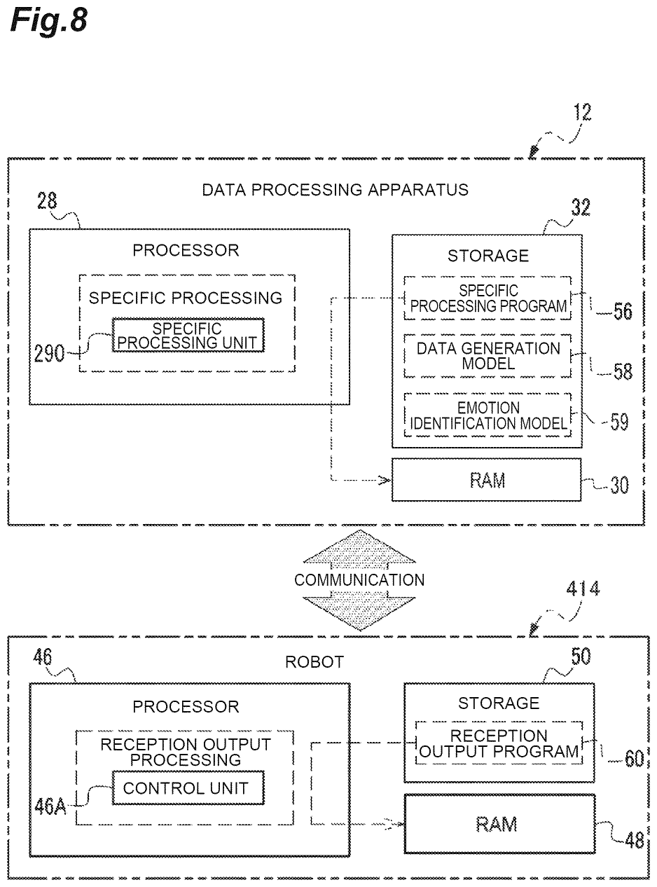

FIG. 8 illustrates an example of main functions of the data processing apparatus 12 and the robot 414. As illustrated in FIG. 8, in the data processing apparatus 12, identification processing is performed by the processor 28. An identification processing program 56 is stored in the storage 32.

The identification processing program 56 is an example of a “program” according to the technology of the present disclosure. The processor 28 reads the identification processing program 56 from the storage 32 and executes the read identification processing program 56 on the RAM 30. The identification processing is realized by the processor 28 operating as an identification processing unit 290 in accordance with the identification processing program 56 executed on the RAM 30.

A data generation model 58 and an emotion identification model 59 are stored in the storage 32. The data generation model 58 and the emotion identification model 59 are used by the identification processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, identification processing by the identification processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the identification processing is the same as that in Example 1.1 described in the first embodiment, a description thereof is omitted.

### Example 4.2

Since the flow of the identification processing is the same as that in Example 1.2 described in the first embodiment, a description thereof is omitted.

The identification processing unit 290 transmits a result of the identification processing to the robot 414. In the robot 414, the control unit 46A causes the speaker 240 and the control target 443 to output the result of the identification processing. The microphone 238 acquires voice indicating a user input for the result of the identification processing. The control unit 46A transmits voice data indicating the user input acquired by the microphone 238 to the data processing apparatus 12. In the data processing apparatus 12, the identification processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The identification processing unit 290 performs the above-described identification processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the identification processing unit 290 of the data processing apparatus 12 or the control unit 46A of the smart device 14, but may also be executed by the identification processing unit 290 of the data processing apparatus 12 and the control unit 46A of the smart device 14. Also, the identification processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the identification processing unit 290 of the data processing apparatus 12. For example, an acquisition unit acquires step count data using the camera 42 or the communication I/F 44 of the smart device 14, and the data is processed by the identification processing unit 290 of the data processing apparatus 12. For example, an analysis unit is realized by the identification processing unit 290 of the data processing apparatus 12, and analyzes data from the collection unit and the acquisition unit. For example, a generation unit is realized by the identification processing unit 290 of the data processing apparatus 12, and generates a cooking menu using a generative AI. For example, a provision unit is realized by the output device 40 of the smart device 14 or the identification processing unit 290 of the data processing apparatus 12, and provides the generated cooking menu to a user. The correspondence relationship between each unit and the device or the control unit is not limited to the above-described example, and various changes are possible.

An example form in which the identification processing is performed by the data processing apparatus 12 has been described, but the technology of the present disclosure is not limited to this, and the identification processing may be performed by the robot 414.

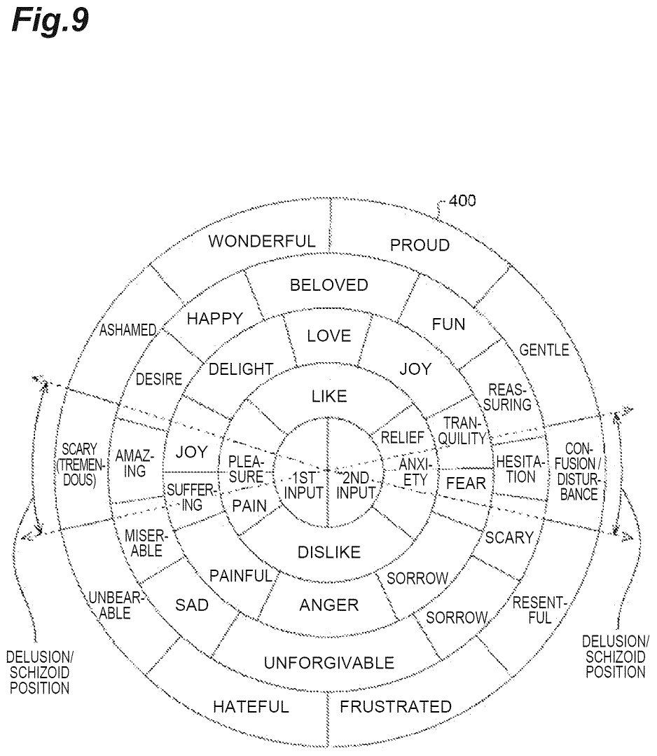

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the identification processing unit 290 may perform identification processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more.”

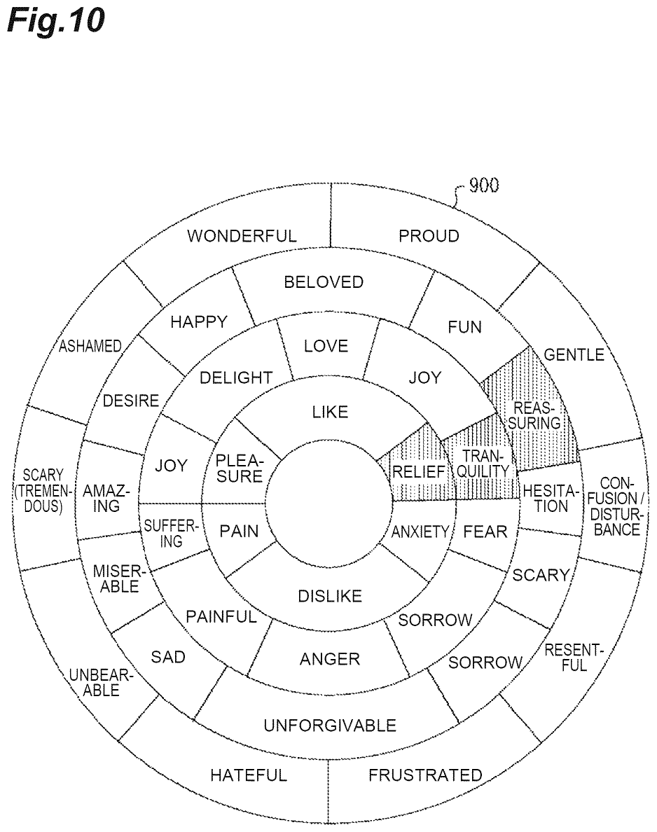

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the identification processing is performed by one computer 22 has been described, but the technology of the present disclosure is not limited to this, and distributed processing for the identification processing may be performed by a plurality of computers including the computer 22. For example, the data generation model 58 may be provided in an external device of the data processing apparatus 12, and the external device may generate data according to the input data.

An example form in which the identification processing program 56 is stored in the storage 32 has been described, but the technology of the present disclosure is not limited to this. For example, the identification processing program 56 may be stored in a portable computer-readable non-transitory storage medium such as a USB (Universal Serial Bus) memory. The identification processing program 56 stored in the non-transitory storage medium is installed in the computer 22 of the data processing apparatus 12. The processor 28 executes the identification processing according to the identification processing program 56.

Also, the identification processing program 56 may be stored in a storage device such as a server connected to the data processing apparatus 12 via the network 54, and the identification processing program 56 may be downloaded in response to a request from the data processing apparatus 12 and installed in the computer 22.

Note that it is not necessary to store all of the identification processing program 56 in a storage device such as a server connected to the data processing apparatus 12 via the network 54, or to store all of the identification processing program 56 in the storage 32, and a part of the identification processing program 56 may be stored.

As hardware resources for executing the identification processing, various processors shown below can be used. Examples of the processor include a CPU, which is a general-purpose processor that functions as a hardware resource for executing the identification processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the identification processing by using the memory.

The hardware resource that executes the identification processing may be configured by one of these various processors, or may be configured by a combination of two or more processors of the same type or different types (for example, a combination of a plurality of FPGAs, or a combination of a CPU and an FPGA). Also, the hardware resource that executes the identification processing may be one processor.

As an example of a configuration with one processor, first, there is a form in which one processor is configured by a combination of one or more CPUs and software, and this processor functions as a hardware resource for executing the identification processing. Second, there is a form in which a processor that realizes the functions of an entire system including a plurality of hardware resources for executing the identification processing with one IC chip, as represented by an SoC (System-on-a-chip) or the like, is used. In this way, the identification processing is realized using one or more of the various processors described above as hardware resources.

Furthermore, as a hardware structure of these various processors, an electric circuit in which circuit elements such as semiconductor elements are combined can be used. Also, the above-described identification processing is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a data collection unit, an analysis unit, and an identification unit. The data collection unit has a function of monitoring user activities on the Internet in real time and collecting communication data and search data. The analysis unit has a function of analyzing the collected data using natural language processing technology to detect keywords that may be related to crime. The identification unit has a function of identifying a related device or account using identification information on the network based on the keywords detected by the analysis unit. This makes it possible to quickly and accurately identify potential risks.

In some examples, the system may further include an evaluation unit and a warning unit. The evaluation unit has a function of collecting past usage history of the device or account identified by the identification unit and quantitatively evaluating potential risks using a machine learning algorithm. The warning unit has a function of automatically issuing a warning to a law enforcement agency when the evaluation unit determines that the risk is high. This enables a prompt response to improve the safety of society.

In some examples, the system may include a history collection unit, wherein the history collection unit has a function of comprehensively collecting the past usage history of the device or account identified by the identification unit by cross-referencing from multiple databases. This makes it possible to grasp the user's behavior patterns in detail and to evaluate potential risks more accurately.

An example system for preventing a potential criminal act on the Internet may include circuitry. The circuitry may be configured to: analyze received input data to detect a specific keyword; identify a related device or account based on the keyword; collect a past usage history of the identified device or account; analyze the collected usage history to evaluate a potential risk; and issue a warning based on an evaluation result.

In some examples, detecting the keyword may include detecting the keyword that may be related to crime by analyzing a plurality of words included in the input data using natural language processing technology. Identifying the device or the account may include identifying the device or the account related to the detected keyword using identification information on a network.

In some examples, collecting the usage history may include comprehensively collecting the past usage history of the identified device or account by performing cross-referencing from a plurality of databases. Evaluating the potential risk may include quantitatively evaluating the potential risk analyzing the collected usage history using a machine learning algorithm. Issuing the warning may include automatically issuing the warning to a law enforcement agency when the evaluation result indicating that the risk is high is obtained.

An example method of preventing a potential criminal act on the Internet may include: analyzing received input data to detect a specific keyword; identifying a related device or account based on the keyword; collecting a past usage history of the identified device or account; analyzing the collected usage history to evaluate a potential risk; and issuing a warning based on an evaluation result.

What is claimed is:

1. A system for preventing internet criminal acts, the system comprising circuitry,
wherein the circuitry is configured to:
analyze received input data to detect a specific keyword;
identify a related device or account based on the keyword;
collect a past usage history of the identified device or account;
analyze the collected usage history to evaluate a potential risk; and
issue a warning based on an evaluation result.

2. The system according to claim 1,
wherein detecting the keyword includes detecting the keyword that may be related to crime by analyzing a plurality of words included in the input data using natural language processing technology, and
wherein identifying the device or the account includes identifying the device or the account related to the detected keyword using identification information on a network.

3. The system according to claim 1,
wherein collecting the usage history includes comprehensively collecting the past usage history of the identified device or account by performing cross-referencing from a plurality of databases,
wherein evaluating the potential risk includes quantitatively evaluating the potential risk analyzing the collected usage history using a machine learning algorithm, and
wherein issuing the warning includes automatically issuing the warning to a law enforcement agency when the evaluation result indicating that the risk is high is obtained.

4. A method of preventing internet criminal acts, the method comprising:
analyzing received input data to detect a specific keyword;
identifying a related device or account based on the keyword;
collecting a past usage history of the identified device or account;
analyzing the collected usage history to evaluate a potential risk; and
issuing a warning based on an evaluation result.
